(19) United States
(12) Patent Application Publication
(10) Pub. No.: US 2024/0214174 A1
(43) Pub. Date: Jun. 27, 2024

(54) SECONDARY CELL ACTIVATION BASED ON CROSS-COMPONENT CARRIER REFERENCE SIGNALS

(71) Applicant: Apple Inc., Cupertino, CA (US)

(72) Inventors: Hong He, San Jose, CA (US); Chunhai Yao, Beijing (CN); Chunxuan Ye, San Diego, CA (US); Dawei Zhang, Saratoga, CA (US); Haitong Sun, Cupertino, CA (US); Oghenekome Oteri, San Diego, CA (US); Seyed Ali Akbar Fakoorian, San Diego, CA (US); Wei Zeng, Saratoga, CA (US); Weidong Yang, San Diego, CA (US)

(73) Assignee: Apple Inc., Cupertino, CA (US)

(21) Appl. No.: 17/802,519

(22) PCT Filed: Sep. 24, 2021
(86) PCT No.: PCT/CN2021/120369

§ 371 Date: Mar. 30, 2023

(51) Int. Cl. H04L 5/00

(52) U.S. Cl. CPC H04L 5/0098; H04L 5/001; H04L 5/005

(57) ABSTRACT

The present application relates to devices and components including apparatus, systems, and methods to perform a secondary cell (SCell) activation. A network node can send a UE a command to activate a component carrier, where this component carrier is associated with other component carriers of a component carrier group. In turn, the UE can determine one or more cross-component carrier reference signal(s) received on one or more activated component carriers of the component carrier group for use in the activation of the component carrier.

Fifth generation mobile network (5G) is a wireless standard that aims to improve upon data transmission speed, reliability, availability, and more. In 5G new radio (NR), a transmission configuration indication (TCI) state is used to establish the quasi co-location (QCL) connection between a target reference signal (RS) and a source RS. TCI states are configured for a physical downlink control channel (PDCCH) or a physical downlink shared channel (PDSCH) in order to convey the QCL indication for the respective RS.

### BRIEF DESCRIPTION OF THE DRAWINGS

FIG. 1 illustrates an example of a network environment, in accordance with some embodiments.

FIG. 2 illustrates an example of dual connectivity environment, in accordance with some embodiments.

FIG. 3 illustrates an example of activating a serving cell, in accordance with some embodiments.

FIG. 4 illustrates an example of a timing diagram of a secondary cell (SCell) activation, in accordance with some embodiments.

FIG. 5 illustrates another example of grouping component carriers for an SCell activation, in accordance with some embodiments.

FIG. 6 illustrates an example of a transmission configuration indicator (TCI) state configuration for an SCell activation, in accordance with some embodiments.

FIG. 7 illustrates an example of cross-component carrier reference signals usable in an SCell activation based on a TCI state configuration, in accordance with some embodiments.

FIG. 8 illustrates an example of an SCell activation command, in accordance with some embodiments.

FIG. 9 illustrates an example of cross-component carrier reference signals usable in an SCell activation based on a set of rules, in accordance with some embodiments.

FIG. 10 illustrates an example of an operational flow/algorithmic structure for an SCell activation, in accordance with some embodiments.

FIG. 11 illustrates an example of an operational flow/algorithmic structure for a TCI state-based SCell activation, in accordance with some embodiments.

FIG. 12 illustrates an example of an operational flow/algorithmic structure for a rule-based SCell activation, in accordance with some embodiments.

FIG. 13 illustrates another example of an operational flow/algorithmic structure for an SCell activation, in accordance with some embodiments.

FIG. 14 illustrates an example of receive components, in accordance with some embodiments.

FIG. 15 illustrates an example of a UE, in accordance with some embodiments.

FIG. 16 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Generally, a user equipment (UE) may be configured to use multiple component carriers for communications to and from a network. In an example, a first set of component components is configured for the UE and is deactivated, whereas a second set of components carrier is configured for the UE and is activated. The component carriers across the two sets can be grouped together for secondary cell (SCell) activation, whereby, per this grouping, cross-component carrier reference signals are usable to reduce the latency, overhead, and power consumption associated with the SCell activation. The UE can receive an SCell activation command to activate a deactivated component carrier of the first set. Based on the grouping, the UE can determine on or more reference signals on one or more activated component carriers of the second set and use the determined reference signal(s) in the SCell activation procedure. As such, reference signals from other component carriers can be used in the activation of a deactivated component carrier. Such reference signals are referred to herein as cross-component carrier reference signals. The grouping of the plurality of component carriers can be indicated to the UE explicitly via, for instance, dedicated radio resource control (RRC) signaling, or implicitly in, for instance, a transmission configuration indication (TCI) state configuration. If a TCI state configuration is used, the UE can determine the cross-component carrier reference signals based on a TCI state and the related information in the TCI state configuration. Otherwise, the UE can implement a set of rules to determine the cross-component carrier reference signals. These and other aspects of the present disclosure are disclosed herein next.

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities that is a network node of a communications network (or, more briefly, network) and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

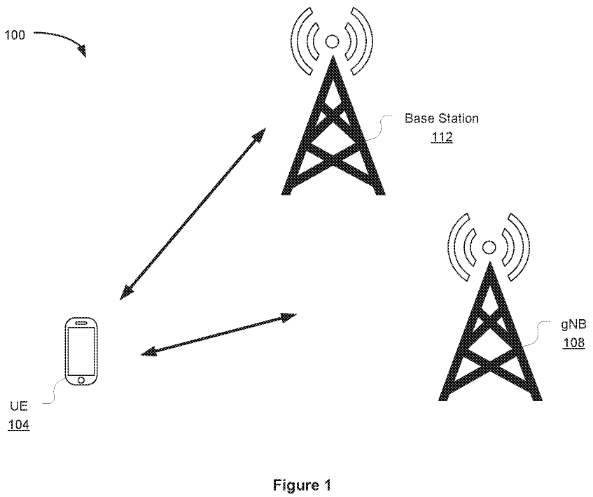

FIG. 1 illustrates a network environment 100, in accordance with some embodiments. The network environment 100 may include a UE 104 and a gNB 108. The gNB 108 may be a base station that provides a wireless access cell, for example, a Third Generation Partnership Project (3GPP) New Radio (NR) cell, through which the UE 104 may communicate with the gNB 108. The UE 104 and the gNB 108 may communicate over an air interface compatible with 3GPP technical specifications, such as those that define Fifth Generation (5G) NR system standards.

The gNB 108 may transmit information (e.g., data and control signaling) in the downlink direction by mapping logical channels on the transport channels, and transport channels onto physical channels. The logical channels may transfer data between a radio link control (RLC) and MAC layers, the transport channels may transfer data between the MAC and PHY layers, and the physical channels may transfer information across the air interface. The physical channels may include a physical broadcast channel (PBCH), a physical downlink control channel (PDCCH), and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in a synchronization signal (SS)/PBCH block. The SS/PBCH blocks (SSBs) may be used by the UE 104 during a cell search procedure (including cell selection and reselection) and for beam selection.

The PDSCH may be used to transfer end-user application data, signaling radio bearer (SRB) messages, system information messages (other than, for example, MIB), and paging messages.

The PDCCH may transfer DCI that is used by a scheduler of the gNB 108 to allocate both uplink and downlink resources. The DCI may also be used to provide uplink power control commands, configure a slot format, or indicate that preemption has occurred.

The gNB 108 may also transmit various reference signals to the UE 104. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include channel status information reference signals (CSI-RS). The CSI-RS may be a multi-purpose downlink transmission that may be used for CSI reporting, beam management, connected mode mobility, radio link failure detection, beam failure detection and recovery, and fine tuning of time and frequency synchronization.

The reference signals and information from the physical channels may be mapped to resources of a resource grid. There is one resource grid for a given antenna port, subcarrier spacing configuration, and transmission direction (e.g., downlink or uplink). The basic unit of an NR downlink resource grid may be a resource element, which may be defined by one subcarrier in the frequency domain and one orthogonal frequency division multiplexing (OFDM) symbol in the time domain. Twelve consecutive subcarriers in the frequency domain may compose a physical resource block (PRB). A resource element group (REG) may include one PRB in the frequency domain and one OFDM symbol in the time domain, for example, twelve resource elements. A control channel element (CCE) may represent a group of resources used to transmit PDCCH. One CCE may be mapped to a number of REGs, for example, six REGs.

The UE 104 may transmit data and control information to the gNB 108 using physical uplink channels. Different types of physical uplink channels are possible including, for instance, a physical uplink control channel (PUCCH) and a physical uplink shared channel (PUSCH). Whereas the PUCCH carries control information from the UE 104 to the gNB 108, such as uplink control information (UCI), the PUSCH carries data traffic (e.g., end-user application data) and can carry UCI.

The UE 104 and the gNB 108 may perform beam management operations to identify and maintain desired beams for transmission in the uplink and downlink directions. The beam management may be applied to both PDSCH and PDCCH in the downlink direction, and PUSCH and PUCCH in the uplink direction.

In an example, communications with the gNB 108 and/or the base station can use channels in the frequency range 1 (FR1) band (between 40 Megahertz (MHz) and 7,125 MHz), frequency range 2 (FR2) band (between 24,250 MHz and 52,600 MHz), and/or other frequency bands. The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device should applies a clear channel assessment (CCA) check before using the channel.

As further illustrated in FIG. 1, the network environment 100 may further include a base station 112 with which the UE 104 may also connect. The base station 112 supports the same RAT as the gNB 108 (e.g., the base station 112 is also a gNB). Additionally or alternatively, the base station 112 supports a different RAT (e.g., Long-Term Evolution (LTE) eNB).

In an example, the UE 104 supports dual connectivity (DC), whereby the UE 104 can connect and exchange data simultaneously with the gNB 108 and the base station 112. Additionally or alternatively, the UE 104 supports carrier aggregation (CA), whereby the UE 104 can connect and exchange data simultaneously over multiple component carriers (CCs) with the gNB 108 and/or the base station 112. The CCs can belong to a same frequency band, in which case they are referred to as intra-band CCs. Intra-band CCs can be contiguous or non-contiguous. The CCs can also belong to different frequency bands, in which case they are referred to as inter-band CCs. A serving cell can be configured for the UE 104 to use a CC. A serving cell can be a primary (PCell) or primary secondary cell (PSCell), or a secondary cell (SCell). Multiple serving cells can be activated via an SCell activation procedure where the component carriers of these serving cells can be intra-band contiguous, intra-band non-contiguous, or inter-band. The serving cells can be collocated or non-collocated.

Generally, when the UE 104 is configured with one or more serving cells, the gNB 108 may activate and deactivate the configured serving cells. Activation and deactivation typically does not apply to a PCell (or PSCell). After an SCell is configured, such as via higher layer signaling, the SCell is in a deactivated state. An SCell activation procedure is used to activate the SCell and enable transmission/reception on the SCell (e.g., on PDSCH, PDCCH, PUSCH of the SCell). The SCell activation procedure may be triggered when, for instance, there is a need of more data throughput or to load balance traffic on the PCell (or PSCell). The SCell can be activated depending on its channel quality and can be deactivated if its channel quality is low.

Furthermore, transmissions that use different antenna ports may experience different radio channels. However, in some situations, different antenna ports may share common radio channel characteristics. For example, different antenna ports may have similar Doppler shifts, Doppler spreads, average delay, delay spread, or spatial receive parameters (e.g., properties associated with a downlink received signal angle of arrival at the UE 104). Antenna ports that share one or more of these large-scale radio channel characteristics may be said to be quasi co-located with one another. 3GPP has specified four types of QCL relationship between reference signals to indicate which particular channel characteristics are shared. In QCL Type A, antenna ports share Doppler shift, Doppler spread, average delay, and delay spread. In QCL Type B, antenna ports share Doppler shift and Doppler spread. In QCL Type C, antenna ports share Doppler shift and average delay. In QCL Type D, antenna ports share spatial receiver parameters.

The gNB 108 may provide TCI state information to the UE 104 to indicate QCL relationships between antenna ports used for reference signals (e.g., synchronization signal/PBCH or CSI-RS) and downlink data or control signaling, for example, PDSCH or PDCCH. The gNB 108 may use a combination of RRC signaling, MAC control element signaling, and DCI to inform the UE 104 of these QCL relationships.

TCI states are configured for PDCCH, PDSCH and CSI-RS in order to convey the QCL indication for the respective reference signal (RS). In FR1 QCL Types A-C and in FR2 QCL types A-D are applicable. The QCL Type D for FR2 indicates that PDCCH/PDSCH/CSI-RS is transmitted with the same spatial filter as the reference signal associated with that TCI. In FR2, the network can indicate a transmit beam change for PDSCH or PDCCH by switching the TCI state.

The UE 104 may be configured with a TCI list for PDSCH and PDCCH via RRC. The TCI states for PDCCH is a subset of those for PDSCH. For PDCCH, the network configures the active TCI state via MAC CE. RRC can configure up to one-hundred twenty-eight TCI states for PDSCH. The UE can have up to eight activated TCI states via MAC CE, although the embodiments of the present disclosure are not limited as such.

When the UE 104 is configured with the higher layer parameter tci-PresentlnDCI that is set as ‘enabled’ for the CORESET scheduling the PDSCH, the TCI field is present in DCI format 1_1. If the scheduling offset between scheduling and PDSCH is larger than Threshold-Sched-Offset and TCI field is present, the TCI state for PDSCH is indicated via DCI. If the tci-PresentlnDCI is not configured or PDSCH is scheduled using DCI format 1_0 or the scheduling offset between PDCCH and PDSCH is smaller than Threshold-Sched-Offset, PDSCH follows the TCI of PDCCH. Thresh-old-Sched-Offset is based on UE capability timeDuration-ForQCL.

TCI state change and corresponding beam switch may be initiated via MAC CE or DCI. When TCI for PDSCH is indicated by DCI, the TCI state or beam switch can be configured via DCI. DCI based TCI state switch is applicable to PDSCH. When PDSCH follows the TCI state of PDCCH, for a beam switch the TCI state of PDCCH is first initiated via MAC CE. Hence, MAC CE-based TCI state switch can be applicable to PDCCH.

When the network activates a new TCI state via MAC CE for PDCCH or via DCI for PDSCH, the UE 104 is allowed some time to prepare to receive with the new TCI state. In order to successfully receive with the new TCI state, the UE 104 needs to know the receive (RX) beam corresponding to the new TCI state and the relevant time offset/frequency offset (TO/FO).

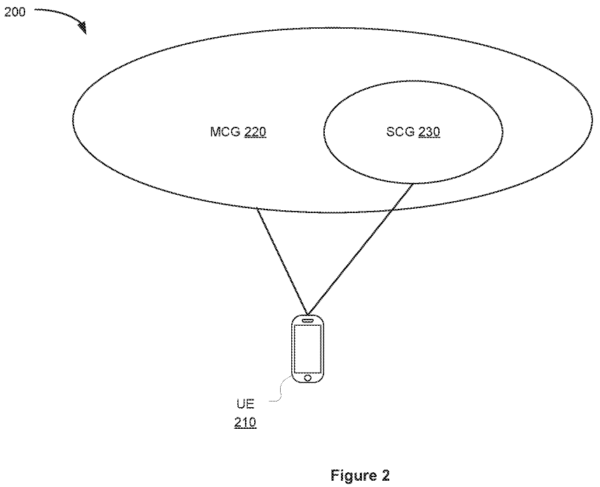

FIG. 2 illustrates an example of dual connectivity environment 200, in accordance with some embodiments. As indicated above, dual connectivity (also referred to as DC) is an operational mode in which a UE 210 is configured to use radio resources of two network nodes, referred to as master node (MN) and a secondary node (SN), where these nodes are connected via a back-haul. The dual connectivity enables the UE 210 to simultaneously transmit and receive data on multiple component carriers from two cell groups via the MN and the SN. In an example, each of the MN and SN can be a gNB or an eNB. The cell groups can be a master cell group (MCG) provided by the MN and a secondary cell group (SCG) provided by the SN.

In the illustration of FIG. 2, the UE 210, which is similar to the UE 104 of FIG. 1, maintains two connections, one with an MCG 220 and one with an SCG 230. The MCG 220 includes multiple carriers, each corresponding to a serving cell for the UE 210. The PCell is activated, whereas remaining serving cells of the MCG 220 may or may not be activated. Similarly, the SCG 230 includes multiple carriers, each corresponding to a serving cell for the UE 210. The primary cell in the SCG 230 (also referred to as PSCell) is activated, whereas remaining serving cells of the SCG 230 may or may not be activated. The UE 210 supports simultaneous reception and transmission over its two connections (also referred to as primary leg and secondary leg) with the MCG 220 and the SCG 230. A split-bearer situation can also be supported, whereby for small data amount, transmission via the primary leg may be sufficient. For large data amount, transmission via both legs can occur.

As indicated above, each of the MN and SN can be a gNB or an eNB. This can result in different deployment configurations for the MCG 220 and the SCG 230. These configurations include LTE-LTE DC, LTE-NR DC, NR-LTE DC, and NR-NR DC. Further, synchronous and asynchronous communications in the dual connectivity can be provided. With synchronous NR-DC, the MCG 220 and the SCG 230 are frame and slot-aligned (e.g., the serving cells in these two cell groups are synchronized). Conversely, with asynchronous NR-DC, the MCG 220 and the SCG 230 need not be frame and slot-aligned (e.g., the serving cells in these two cell groups need not be synchronized).

In an example, each of the MCG 220 and the SCG 230 includes a different set of carriers from the same or a different set of bands. This can result in intra-band DC, inter-band DC, and inter-band DC with intra-band components. In intra-band DC, carriers from the same band are present in the MCG 220 and the SCG 230. In comparison, in inter-band DC, carriers from different bands are present in the MCG 220 and the SCG 230. Inter-band DC with intra-band components can be a mix of intra-band DC and inter-band-DC, whereby carriers from different bands are present in the MCG 220 and the SCG 230 while a cell group (e.g., the MCG 220, the SCG 230, or both) include carriers from the same band.

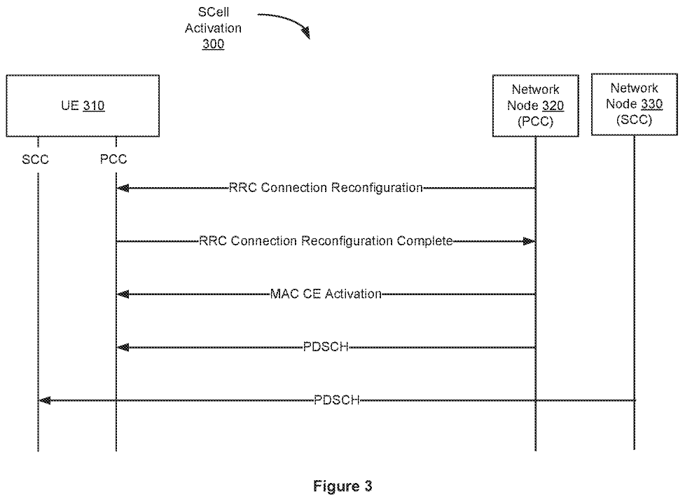

FIG. 3 illustrates an example of activating a serving cell, in accordance with some embodiments. In this example, the to-be-activated serving cell is an SCell that belongs to an MCG or an SCG and the activating is shown as an SCell activation 300. As illustrated, a UE 310 is in communication with a network node 320 of the MCG (e.g., a master node as a gNB), where the communication uses a PCell (illustrated in FIG. 3 as a primary component carrier (PCC)). The network node 320 configures the UE 310 to use a secondary component carrier (SCC) of an SCell provided by a second network node 330 of the SCG (e.g., a secondary node, such as a gNB or an eNB). The two network nodes 320 and 330 are shown as being separate from each other, whereby the SCell activation 300 applies to the SCG. However, embodiments of the present disclosure are not limited as such, for example, the two network nodes 320 and 330 may belong to a same cell group and/or they may be a single network node that supports intra-band or inter-band CCs.

The UE 310 is initially configured via an RRC connection reconfiguration indicating the SCell. The SCell is added to the configuration of the UE 310, but is in a deactivated state. To activate the SCell, the network node 320 can send an SCell activation command, such as a MAC CE or an enhanced DCI, identifying the SCell. The SCell activation triggers the UE 310 to activate the SCell, where the activation includes performing various measurements and reporting back to network node 320. Once activated, a PDSCH can be available to the UE 310 on the SCell, in addition to the PDSCH on the PCell.

Typically, the network (e.g., the network node 320 and/or a radio network controller (RNC)) uses an information element (IE) of CellToAddModList in RRCConnectionReconfiguration message to add an SCell of the UE 310. At the time of SCell addition, the gNB 320 can send different types of information to the UE 310 via a RRCConnectionReconfiguration message. The information can include an SCellIndex that identifies the SCell; a cellIdentification, which is a physical cell identity and downlink carrier frequency (EARFCN); radioResourceConfigCommonSCell, which is an IE for sending system information of the SCell; radioResourceConfigCommonSCell that contains downlink configurations, such as downlink bandwidth, number of antenna ports, and the like; radioResourceConfigDedicatedSCell, which is an IE containing UE specific configurations for the SCell; and radioResourceConfigDedicatedSCell, which includes downlink dedicated configurations, such as information related to transmission mode for the SCell, cross-carrier scheduling configuration, SCell CSI-RS information, and the like. Upon receiving theRRCConnectionReconfiguration message, the UE 310 can execute the SCell addition command and send a message indicating that the RRC connection reconfiguration is complete.

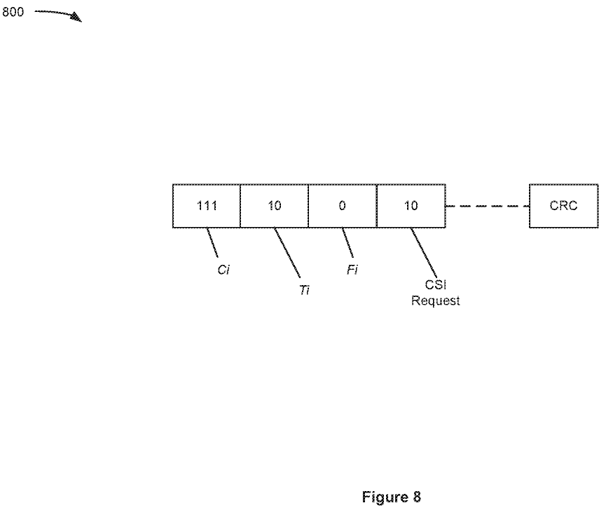

Once configured, the SCell activation can be triggered based on the SCell activation command. A MA CE can be used as the SCell activation command and is identified by a MAC protocol data unit (PDU) sub-header with a unique logical channel identifier (LCID), such as “11011.” The MAC CE element includes fields, each of which indicates an SCell with a SCell Index. The MAC CE carries a bitmap for the activation and deactivation of SCells, wherein the bitmap a field set to “1” denotes activation of the corresponding SCell, while a field set to “0” denotes deactivation. With the bitmap, SCells can be activated and deactivated individually, and a single activation/deactivation command can activate/deactivate a subset of the SCells. A DCI having a specific format can also be used, whereby one or more fields of the DCI can carry the information for the SCell activation. Examples of the fields usable in such MAC CE or DCI are further described in FIG. 8.

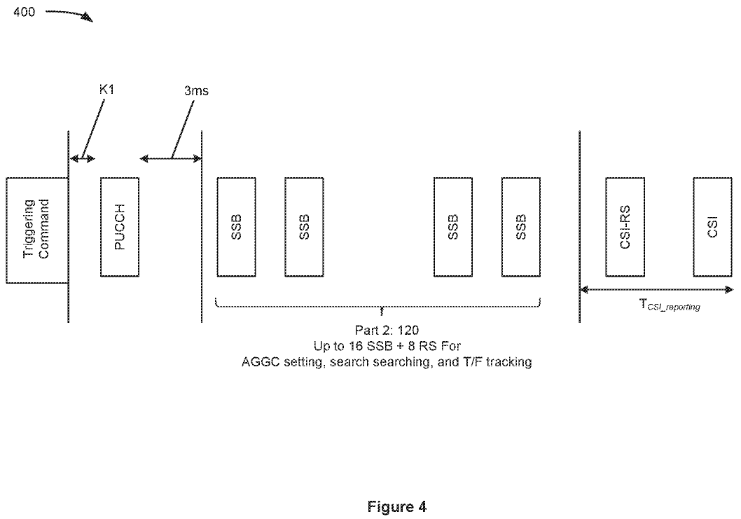

FIG. 4 illustrates an example of a timing diagram 400 of an SCell activation, in accordance with some embodiments. Generally, with dual connectivity, UE and network power consumption can be much larger than that of LTE, due to maintaining two radio links simultaneously. In some cases NR UE power consumption can be three to four times higher than LTE. As explained herein above, a master node provides the basic coverage. When UE data rate need changes dynamically, e.g. from high to low, a secondary node may be (de)activated to save UE and network power consumption.

Enhancements are being considered for supporting, in association with FR1 and FR2, efficient activation/de-activation mechanism for one SCG and SCells, and SCell activations for NR CA based on RANi leading mechanisms.

Generally, to successfully activate an SCell, antenna gain control (AGC) setting and cell searching and Time-Frequency (T/F) tracking are needed such that a UE can determine the receive (Rx) beam and the relevant time offset/frequency offset (TO/FO). The AGC setting and T/F tracking rely on the processing of reference signals, and this processing can use a certain time period that corresponds to an activation delay. 3GPP Technical Specification TS 38.133 V16.7.0 (2021 Apr. 12) defines activation delay for several conditions/scenarios.

For an unknown SCell case, the time taken by the UE to perform AGC setting, cell searching and T/F tracking can span up to twenty-four SSBs on the SCell that is being activated, which is the largest component of the delay. One of the possible enhancements is the use of temporary reference signals to reduce the latency caused by the large SSB periodicity. However, the use of temporary reference signal (RSs) can result in a large amount of RS signaling overhead due to Rx beam sweeping at UE side in unknown SCell case. An SCell can be considered unknown if its state is unknown to the UE by, for instance, not being previously detected by the UE.

In the illustration of FIG. 4, the timing diagram 400 relates to an unknown SCell activation for FR2. Upon receiving a triggering command (e.g., an SCell activation command), the UE can send HARQ feedback on PUCCH after K1 number of slots. After a certain gap (e.g., 3 ms in the illustration of FIG. 4), the UE can start detecting and processing SSBs on the SCell that is being activated, as indicated in “part 2” of FIG. 4. The “part 2” can be up to twenty-four SSBs in accordance with the current SCell activation framework for unknown SCells. Thereafter, CSI-RS by the UE that then reports CSI within a T_{CSI_reporting} time window.

The SCell activation delay can be reduced by exploring some channel properties across CCs in carrier aggregation (CA), including intra-band CA or inter-band CA. For example, for intra-band CC or adjacent inter-band CC, some radio channel properties are shared among the activated CCs and being activated CC, which can be exploited to expedite the SCell activation process with minimized RS signaling overhead. Such properties can include QCL-type A and QCL-type D properties (e.g., Doppler shift, Doppler spread, average delay, delay spread, and spatial Rx parameter properties).

Embodiments of the present disclosure provide methods and apparatus to reduce the latency of activation/deactivation procedure for SCG and SCells by exploiting the ‘QCL-TypeA’ and ‘QCL-TypeD’ RS transmitted on the other intra-band or inter-band active CCs. such reference signals are generally referred to as cross-component carrier reference signals. For example, when a deactivated component carrier is being activated as part of an SCell activation, a QCL-TypeA reference signal (e.g., an SSB and/or a periodic tracking reference signal (P-TRS)) on another activated component carrier can be used for the AGC setting and T/F tracking. Additionally or alternatively, a QCL-TypeD reference signal (e.g., a CSI-RS) on the other activated component carrier or yet a different activated component carrier can be used for the CSI reporting.

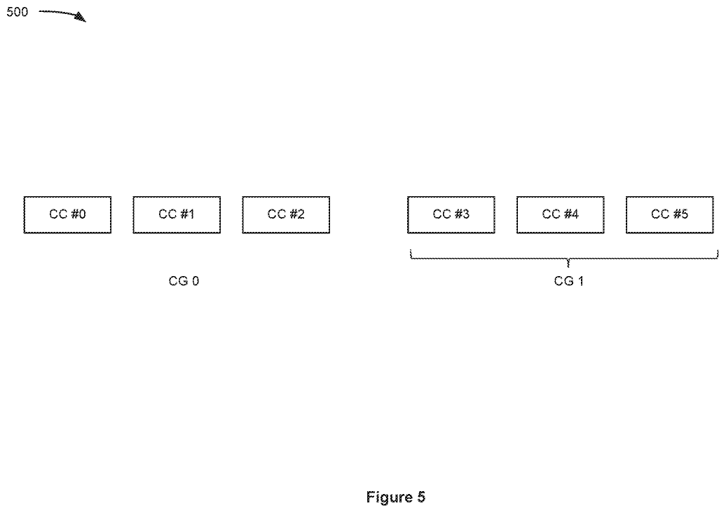

FIG. 5 illustrates another example 500 of grouping component carriers for an SCell activation, in accordance with some embodiments. The component carriers may be configured for a UE (e.g., via RRC signaling) and associated with one or more groups (two groups are illustrated in FIG. 5). A group of component carriers can indicate that, when a component carrier is to be activated from the group, cross-component carrier reference signals of the group can be used for the activation. In particular, while some of the group's component carriers are already activated for the UE, the UE can activate, for an SCell, a deactivated component carrier of the group by using one or more reference signals on one or more of the already-activated components carriers.

Generally, the component carrier grouping maybe performed at a network node (e.g., a gNB that configures the UE), based on the radio frequency relationships and QCL relationships among the component carriers. For instance, component carriers that are co-located and within a same band (e.g., intra-band CCs) can be associated with the same component carrier group. These component carriers can be in contiguous or non-contiguous bands. In another illustration, inter-band component carriers that are in adjacent bands can be associated with the same component carrier group. In both illustrations, component carriers in a same component carrier group commonly share a same RF chain at the network node side, such that it is possible to leverage a set of shared reference signal for AGC settling and/or T/F tracking purpose in order to achieve a fast SCell activation.

In the illustration of FIG. 5, the first component carrier group (shown as “CG 0”) includes three component carriers having indices “0,” “1,” and “2.” The second component carrier group (shown as “CG 1”) includes three other component carriers having indices “3,” “4,” and “5.” Of course, the two component carrier groups are shown for illustrative purposes and the embodiments of the present disclosure can use a different number of component carrier groups and/or a different number of component carriers per component carrier group. Based on the grouping, reference signals received on one or more activated component carriers of the first component carrier group can be used in the activation of a deactivated component carrier of the first group. In comparison, reference signals received on one or more activated component carriers of the second component carrier group can be used in the activation of a deactivated component carrier of the second group. However, reference signals received on one or more activated component carriers of the first component carrier group cannot be used in the activation of a deactivated component carrier of the second group and vice versa.

QCL-TypeA reference signals, including SSB, TRS, periodic CSI-RS, and/or SP-CSI-RS on one component carrier of a component carrier group (e.g. CC #0) may be used for T/F tracking and/or AGC setting in an activation process for another component carriers of the same component carrier group (e.g. CC #1). Further, some differences may exists between pairs of component carriers in a same component carrier group (e.g., the pair of CC #0 and CC #1). Such differences may impact the T/F tracking and/or AGC setting. Accordingly, a power offset value Δ_{A} may be used, in association with the QCL-TypeA reference signals, to account for the differences in terms of sum of path loss and coupling loss between the component carriers of the pair (e.g. between CC #0 and CC #1). In an illustration, the power offset value Δ_{A} may be provided by higher layers (e.g., by the network node to the UE) for each component carrier pair (e.g., the pair of CC #0 and CC #1) in a component carrier group. In another illustration, the UE may derive the power offset value Δ_{A} for each pair based on, for instance, the frequency separation between the component carriers of the pair. In this illustration, no signaling from the network node may be needed.

QCL-TypeD reference signals, including SSB and/or periodic-CSI-RS on one component carrier of a component carrier group (e.g. CC #0) may be used for maybe used for aperiodic CSI-RS reception on another component carrier of the group (e.g., CC #1), thereby reducing the SCell activation latency for a unknown SCell (e.g., as defined in clause 8.3.2 of 3GPP TS 38.133 V16.7.0 (2021 Apr. 12) by determining the spatial relation and avoiding beam-sweeping for the aperiodic CSI-RS reception.

As described herein above, the grouping of the component carriers can be explicitly indicated to the UE via RRC signaling. For instance, the network node can send an RRC message to the UE, where this message indicates the identifier of each component carrier group and the identifiers of the component carriers that are associated with the group. An example of the RRC messaging is as follows (CG refers to a component carrier group):

| | |
|---|---|
| CG-Config :: = | Sequence { |
| CG-ToReleaseList | Sequence (SIZE (1..maxNrofTAGs)) OF |
| | CG-Id; |
| CG-ToAddModList | Sequence (SIZE (1..maxNrofTAGs)) of CG-Id |

}

| ConfigSCell-r17 ::= | Sequence { | |
|---|---|---|
| CG-Id | CG-Id-r17 | OPTIONAL - Need OP} |

As also described herein above, the grouping of the component carriers can be implicitly indicated to the UE. For instance, the network node sends, via RRC signaling, a TCI state configuration for a particular component carrier. This configuration information indicates other component carriers and reference signals on such component carriers that can be used for the activation of the particular component carrier. As such, the UE can assume that the particular component carriers and the other component carriers are grouped together for an SCell activation that corresponds to the particular component carrier, whereby the network node does not define or provide an identifier of this component carrier group to the UE.

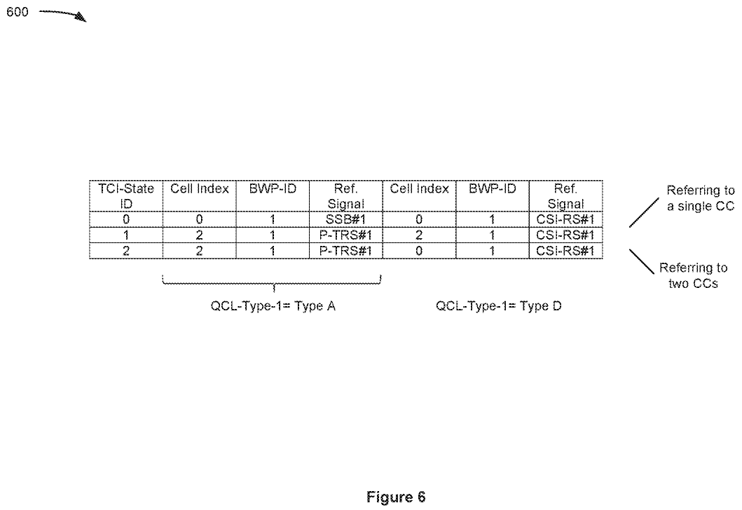

FIG. 6 illustrates an example of a TCI state configuration 600 for an SCell activation, in accordance with some embodiments. Although FIG. 6 illustrates a single TCI state configuration, a UE can be configured with a list of TCI state configurations. Each TCI state configuration in the list can be associated with a component carrier, and, conversely, each component carrier can be associated with one or more TCI state configurations.

Generally, a TCI state configuration associated with a component carrier of a component carrier group can indicate sets of cross-component carrier reference signals for an SCell activation that uses the component carrier. A set of cross-component carrier reference signals can be received on one or more active component carriers of the component group. Further, the set can include one or more types of reference signals, such as a reference signal for AGC setting and T/F tracking (e.g., a QCL-TypeA reference signal) and/or a reference signal for CSI-RS reception (e.g., a QCL-TypeD reference signal). Further, the TCI state configuration can include multiple TCI states. Each TCI state can correspond to one of the sets of cross-component carrier reference signals and one or more component carriers on which this sent is received. For multiple reference signals of a same set, and depending on the TCI state, the reference signal may, but need not, be received on a single component carrier. Other information can also be included in the TCI state configuration, such as a cell index that corresponds to each component carrier and a bandwidth part (BWP) identifier.

In the example illustration of FIG. 6, the TCI state configuration 600 may be stored as a table by the UE (although other types of data structure are possible). A TCI state may be associated with one or two downlink reference signals with a corresponding QCL type. In particular, the table lists the identifiers of the TCI states (shown under the TCI-State ID column header). For each identified TCI state, a first combination that corresponds to a first reference signal and a second combination that corresponds to a second reference signal are indicated.

The first combination can take the form of <Cell-Index, BWP-ID, Reference Signal #1, QCL-type #1>. In an illustration, QCL-type #1 is mandated to be ‘QCL-TypeA’, which is used for AGC settling and T/F tracking (e.g., to derive the following values ‘{Doppler shift, Doppler spread, average delay, delay spread}’ for subsequent PDSCH reception without need of a reference signal being transmitted on the SCell being activated).

The second combination can take the form of <Cell-Index, BWP-ID, Reference Signal #2, QCL-type #2> and can be optionally configured. In an illustration, the QCL-type #2 maybe ‘QCL-TypeD’ to derive the spatial Rx parameters for reception of CSI/RS or PDSCH on the SCell being activated. The presence of this second combination can depend on the frequency range (e.g. only present for FR2).

A serving cell associated with a cell index in the first and second combination maybe in a same frequency band (e.g., intra-band CC) or in different frequency band (e.g., inter-band CC). As also explained herein above, for a TCI state, the two reference signals can be received on the same component carrier (e.g., the TCI state refers to a single CC) or on two component carriers (the TCI state refers to two CCs).

When multiple cross-CC TCI-states are configured for a given component carrier, one of these TCI-States maybe explicitly selected by the SCell activation command. An example of such command is further described in FIG. 8.

Referring back to the component carrier group “CG 0” of FIG. 5, the TCI state configuration 600 can be defined for CC #1. TCI state ID “0” indicates that SSB having index “1” and received on CC #0 corresponding to the already activated cell having index “0” can be used for AGC setting and T/F tracking. This state also indicates that CSI-RS having index “1” and received on CC #0 can be used for the CSI reporting. In comparison, TCI state ID “1” indicates that P-TRS having index “1” and received on CC #2 corresponding to the already activated cell having index “2” can be used for AGC setting and T/F tracking. This state also indicates that CSI-RS having index “1” and received on CC #2 can be used for the CSI reporting. TCI state ID “3” indicates that P-TRS having index “1” and received on CC #2 corresponding to the already activated cell having index “2” can be used for AGC setting and T/F tracking. This state also indicates that CSI-RS having index “1” and received on CC #0 can be used for the CSI reporting.

Although FIG. 6 illustrates three TCI states and two combinations, a different number of TCI states and/or a different number of combinations are also possible.

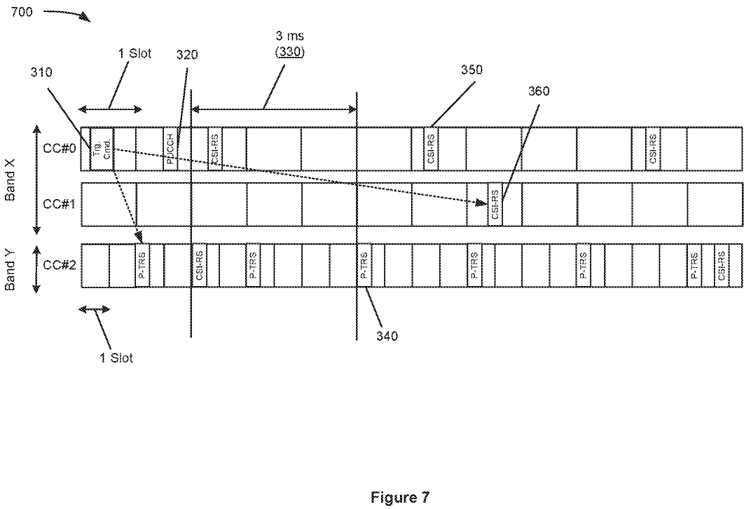

FIG. 7 illustrates an example of cross-component carrier reference signals usable in an SCell activation based on a TCI state configuration, in accordance with some embodiments. Generally, a UE stores the TCI state configuration based on RRC signaling. Subsequently the UE receives and SCell activation command that identifies a TCI state. The UE cna look up the TCI state configuration using the TCI state to determine the cross-component carrier reference signals to use for the SCell activation (e.g., by determining the QCL-TypeA reference signal received on an already activated component carrier for AGC setting and T/F tracking, and by determining the QCL-TypeD reference signal received on the same other component carrier or another already activated component carrier for spatial Rx parameter determination).

In the illustrative example of FIG. 7, reference is made to the component carrier group “CG 0” of FIG. 5 to describe cross-component carrier TCI-State configuration and SCell activation by leveraging the downlink reference signals on other activated component carriers for AGC setting, T/F tracking, and spatial Rx parameter determination in order to reduce reference signal overhead and reduce network and UE power consumption.

As illustrated, three component carriers CC #0, CC #1 and #CC2 are grouped for the UE. CC #0 and CC #1 belong to the same band, whereas CC #2 belongs to an adjacent band and can use a different subcarrier spacing (as indicated with the shorter time length of a slot). Three TCI states are configured by RRC signaling in a TCI state configuration for CC #1 as illustrated in FIG. 6, which is utilized for CC1 fast activation procedure. These cross-component carrier reference signals include SSB #1 on CC #0, P-TRS on CC #2, or beam-formed CSI-RS transmitted on CC #0 or CC #1. CC #0 and CC #2 are already activated. CC #1 is currently deactivated.

The UE receives, on CC #0, a triggering command 710 for activating an SCell that uses CC #1. This triggering command can be an SCell activation MAC CE in slot “n.” The UE responds with HARQ-ACK 320 on PUCCH. in slot ‘n+1’. A 3 ms gap 330 is reserved for intra-UE cross-layers communications, RF retuning, which is pre-known by both the network node (e.g., the gNB) and UE.

The network node indicates to the UE that the third TCI state is to be used for the SCell activation. This indication can be sent by including the corresponding TCI state ID in the triggering command 310. As such, the UE determines to use the P-TRS 320 on CC #2 (e.g., the first P-TRS received on CC #2 after the gap 330), where this P-TRS 320 is configured as “QCL-TypeA” for AGC settling and T/F tracking and correspondingly, no TRS/SSB is needed on CC #1 for this purpose. In addition, the UE determines to apply ‘QCL-TypeD’ CSI-RS 350 on CC #0 (e.g. the first CSI-RS received on CC #0 after the gap 330), to aperiodic CSI-RS 360 on CC #1 for CSI measurement and report.

FIG. 8 illustrates an example of an SCell activation command 800, in accordance with some embodiments. The SCell activation command 800 can include a MAC CE or DCI having an enhanced format, where the MAC CE or the DCI enable a fast SCell activation procedure and reduce the SCell activation delay. For example, this SCell activation command 800 can include a plurality of fields to indicate a component carrier that is being activated and the cross-component carrier reference signals to use. The indication of such signal can take the form of information that indicates a TCI state and/or a portion of the TCI state to apply, where in turn the TCI state and/or the portion thereof identify the reference signals and the component carriers.

In particular, the MAC CE or the DCI includes a first field that indicates an activation/deactivation status of an SCell that corresponds to the deactivated component carrier, a second field that indicates the indicates the TCI state, and a third field that indicates whether a temporary reference signal or the set of cross-component carrier reference signals is to be used. The MAC CE can also include a fourth field that triggers aperiodic CSI-RS transmission that is quasi-collocated (QCLed) with a second reference signal of the set of cross-component carrier reference signals. In this example, the first bits in the first field are set to indicate that the SCell is to be activated, second bits in the second field are set to have a value of an identifier of the TCI state, third bits in the third field are set to indicate the use of the set of cross-component carrier reference signals, and fourth bits in the fourth field are set to indicated the QCLed relationship.

In the illustration of FIG. 8, the first field is a “Cᵢ” field. This field indicates the activation/deactivation status of the SCell with SCell Index, else the MAC entity shall ignore the field. The field is set to “1” to indicate that the SCell with SCell Index is be activated and there is an associated TCI-ID field. The field is set to “0” to indicate that the SCell with SCellIndex is to be deactivated.

The second field is a “Tᵢ” field. This field indicates the TCI-State ID configured by RRC signaling for the SCell being activated, wherein the corresponding TCI state indicates the reference signal(s) on another component carrier(s) that is(are) activated.

The third field is a “Fᵢ” field. This field indicates the presence of temporary reference signal on the SCell being activated for AGC settling and T/F tracking purpose. F₀ refers to the first SCell being activated by the new MAC CE, F₁ to the second one, and so on. The field is set to “0” to indicate the cross-component carrier reference signal(s) indicated by the Tᵢ for the SCell is used and consequently no temporary reference signal is transmitted on the SCell for this purpose; otherwise, it is set to “1” and the UE expects a temporary reference signal is triggered by the MAC CE or DCI.

The third field is also a CSI request field. This field triggers aperiodic CSI-RS transmission that is QCLed with a second reference signal indicated by the Tj if cross-component carrier reference signal is indicated; otherwise, the UE assumes the triggered CSI-RS is QCLed with a temporary reference signal on the component carrier being activated with respect to ‘QCL-TypeD.’

FIG. 7 further provides an example DCI Format that enables dynamically indicating the cross-component carrier reference signal for a deactivated component carrier. Cyclic redundant check (CRC) bits are appended in the DCI. Referring back to the TCI state configuration of FIG. 5 (having three states), the bit maps of each field is shown to trigger the SCell activation of FIG. 6. Of course, different bitmaps and/or sizes of bitmaps are possible depending on the TCI state configuration and the particular activation.

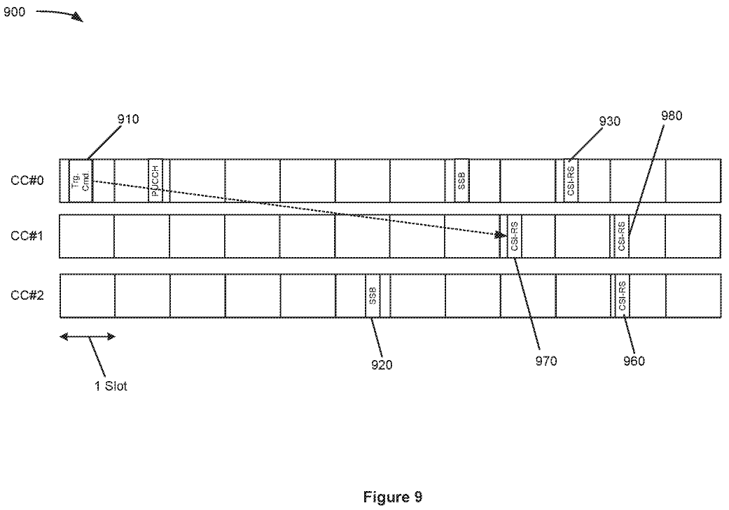

FIG. 9 illustrates an example of cross-component carrier reference signals usable in an SCell activation based on a set of rules, in accordance with some embodiments. As explained herein above, a network node can explicitly indicate to a UE that component carriers are grouped together for an SCell activation that uses cross-component carrier reference signals. This explicit indication can be by means of a component carrier group identifier. No TCI state configuration may need to be sent. Instead, the UE may store a set of rules that, upon receiving an SCell activation command, the UE can apply the rule(s) to determine the cross-component carrier signals to use. Even if a TCI state configuration is defined, the UE can apply the set of rules. That may be the case when, for example, the SCell activation does not identify a TCI state.

In an example, the set of rules indicates that a resource set carrying the QCL-TypeA reference signal on any activated component carrier and occurring first after a number of slots from the SCell activation command in the time domain is to be used as the first reference signal for the SCell activation. The set of rules further indicates that a resource set carrying the QCL-TypeD reference signal on any activated component carrier and occurring first after the number of slots from the activation command in the time domain is to be used as the second reference signal for the SCell activation.

In addition, the set of rules indicates that if an overlap in the time domain occurs between (i) a first QCL-TypeA (or QCL-TypeD) reference signal on a first activated component carrier within a same frequency band as the deactivated component carrier and (ii) a second QCL-TypeA (or QCL-TypeD) reference signal on a second activated component carrier in a different frequency band than the deactivated component carrier, the first QCL-TypeA (or QCL-TypeD) reference signal is to be used for the SCell activation. At a more granular level, the set of rules indicates that if an overlap in the time domain occurs between (i) a first QCL-TypeA (or QCL-TypeD) reference signal on a first activated component carrier within a same frequency band as the deactivated component carrier and (ii) a second QCL-TypeA (or QCL-TypeD) reference signal on a second activated component carrier in the same frequency band, and having a larger component carrier index than the first activated component carrier, the first QCL-TypeA (or QCL-TypeD) reference signal is to be used for the SCell activation based on the lower component carrier index of the first activated component carrier relative to the second activated component carrier.

Furthermore, the set of rules indicates that if a triggered aperiodic CSI-RS on an SCell being activated and corresponding to the deactivated component carrier overlaps in the time domain with the QCL-TypeD reference signal, subsequent receptions on the SCell have a QCL-TypeD association with the QCL-TypeD reference signal. Also, the set of rules indicates that subsequent receptions on an SCell being activated and corresponding to the deactivated component carrier have a QCL-TypeD association with a demodulation reference signal (DMRS) of a PDCCH scheduling the SCell activation command or a PDSCH carrying the SCell activation command.

In an illustration of the above set of rules, FIG. 7 illustrates three component carriers CC #0, CC #1, and CC #2, with CC #0 and CC #2 already activated. The UE receives an SCell activation command (illustrated as a triggering command 910) on CC #0 for CC #1 in slot “n.” The set of rules specify that the first QCL-Type-A reference signal resources and the first QCL-TypeD reference signal resources on any activated component carrier in a same component carrier after a particular slot “n+A” are used. “A” can be defined to be equal to “K1+3Nₛₗₒₜ^{subframe,u},” where “u” is the subcarrier spacing configuration for SCell activation command reception. Based on this rule, the “QCL-TypeA” SSB 920 on CC #2 and “QCL-TypeD” CSI-RS 930 on CC #0 are used for CC #1 activation to reduce latency.

When more than one “QCL-TypeA or “QCL-TypeD” reference signals on different component carrier are overlapping in time domain, the CCs of intra-band is selected. When more than one ‘QCL-A’ or ‘QCL-D’ RSs on different intra-band CCs are overlapping in time domain, the CC with a lowest CC index is selected.

When the triggered A-CSI-RS on the SCell being activated (e.g. CSI-RS 980 on CC #1) is overlapping in time with “QCL-TypeD” reference signal on other component carrier (e.g. RS 960 on CC #2), the UE may assume the subsequent receptions on SCell being activated (e.g. CC #1) are “QCL-TypeD” with regard to the overlapped reference signal (e.g. CSI-RS 960 on CC #2).

The UE may assume the subsequent receptions in SCell activation procedure are “QCL-TypeD” with regard to the DMRS of PDCCH scheduling the SCell activation command or PDSCH carrying the SCell Activation command. Accordingly, the UE can assume the subsequent receptions on CC #1 in SCell activation procedure are “QCL-TypeD” with regard to the DMRS of the activation command 910 on the PDCCH.

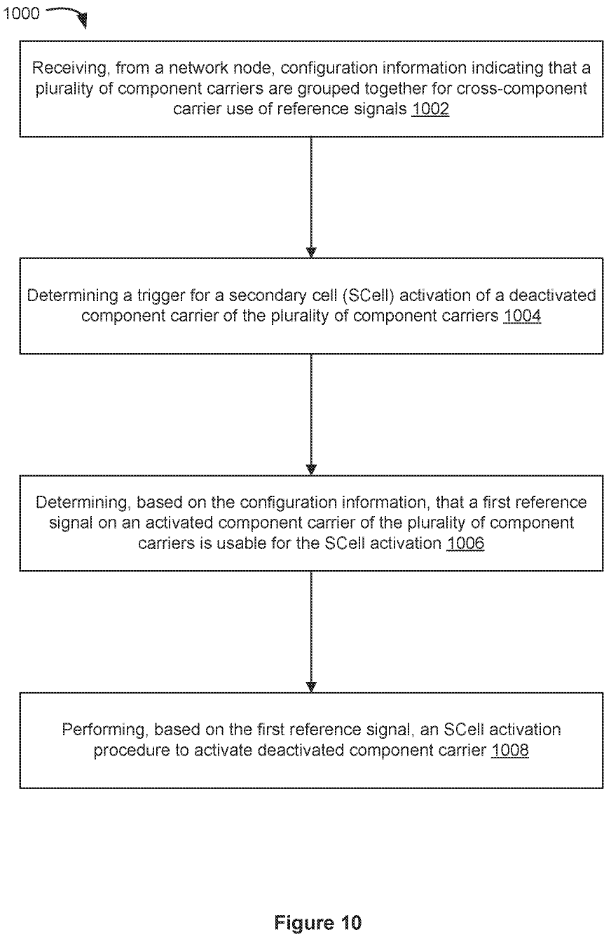

FIG. 10 illustrates an example of an operational flow/algorithmic structure 1000 for an SCell activation, in accordance with some embodiments. A UE, such as the UE 104, 210, 310, or 1500, or components thereof (e.g., processors 1504), can implement the operational flow/algorithmic structure 1000 to improve an SCell activation procedure. The UE can communicate with a network node, such as a gNB.

The operation flow/algorithmic structure 1000 may include, at 1002, receiving, from the network node, configuration information indicating that a plurality of component carriers are grouped together for cross-component carrier use of reference signals. In some embodiments, the configuration information indicates an identifier of a component carrier group and associates this identifier with the plurality of component carriers. In additional or alternative embodiments, the configuration information indicates a TCI state configuration per component carrier, where the TCI state configuration of a component carrier indicates reference signals and their associations with other component carriers of the plurality of component carriers.

The operation flow/algorithmic structure 1000 may also include, at 1004, determining a trigger for a SCell activation of a deactivated component carrier of the plurality of component carriers. In some embodiments, determining the trigger includes receiving an SCell activation command. This command can include a MAC CE or a DCI. The MAC CE or the DCI can at least indicate the component carrier that is to be activated. Additionally, the MAC CE or the DCI can indicate a TCI state.

The operation flow/algorithmic structure 1000 may also include, at 1006, determining, based on the configuration information, that a first reference signal on an activated component carrier of the plurality of component carriers is usable for the SCell activation. In some embodiments, the first reference signal is a cross-component reference signal determined based on the TCI state configuration or a set of rules stored by the UE. The first reference signal may be a QCL-TypeA reference signal or a QCL-TypeD reference signal. Operation 1006 may similarly include determining a second cross-component reference signal that can be received on the activated component carrier or another activated component carrier.

The operation flow/algorithmic structure 1000 may also include, at 1008, performing, based on the first reference signal, an SCell activation procedure to activate deactivated component carrier. In some embodiments, the UE determines the AGC setting and T/F tracking based on the first reference signal and/or a QCL between this first reference signal and a reference signal on the component carrier being activated relationship for Rx spatial determination. In addition, the UE can determine a power offset between the pair of the deactivated component carrier and the activated component carrier, where this power offset can be determined by the US based on frequency separation between the two component carriers or indicated by higher layers. The UE can complete the SCell activation procedure based on the different parameters (e.g., Doppler shift, Doppler spread, average delay, delay spread, spatial receive parameter, power offset).

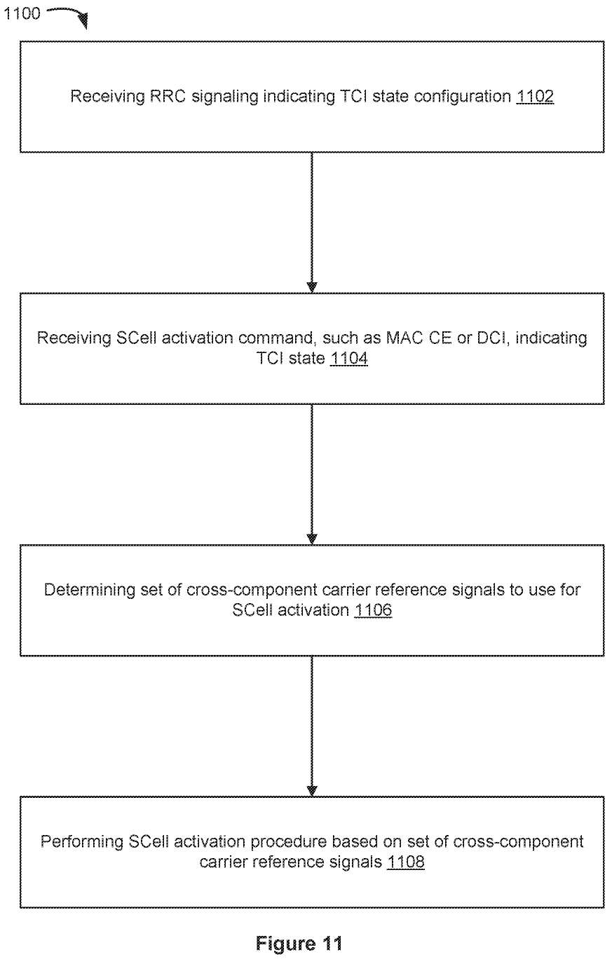

FIG. 11 illustrates an example of an operational flow/algorithmic structure 1100 for a TCI state-based SCell activation, in accordance with some embodiments. Operations of the operational flow/algorithmic structure 1100 are specific to using a TCI state configuration associated with a deactivated component carrier that is being activated. As such, these operations can be implemented as sub-operations of the operational flow/algorithmic structure 1000 of FIG. 10. Some of the operations may be similar. The similarities are not repeated herein in the interest of brevity by equivalently apply to the operational flow/algorithmic structure 1100.

The operation flow/algorithmic structure 1100 may include, at 1102, receiving RRC signaling indicating a TCI state configuration. In some embodiments, a TCI state configuration, similar to the one described in FIG. 6, is received by the UE from the network node for each component carrier that belongs to a component carrier group.

The operation flow/algorithmic structure 1100 may also include, at 1104, receiving an SCell activation command, such as MAC CE or DCI, indicating a TCI state. In some embodiments, the SCell activation command can include multiple fields, such as the ones described in FIG. 8. These fields can indicate a deactivated component carrier to activate and a TCI state to use from the TCI state configuration associated with this deactivated component carrier.

The operation flow/algorithmic structure 1100 may also include, at 1106, determining a set of cross-component carrier reference signals to use for the SCell activation. In some embodiments, the UE determines the identifier of the TCI state from the SCell activation command and uses this identifier in a look-up of the TCI state configuration to determine at least one of a QCL-TypeA reference signal on an activated component carrier of the component carrier group or a QCL-TypeD reference signal on this activated component carrier or another activated component carrier of the component carrier group.

The operation flow/algorithmic structure 1100 may also include, at 1108, performing an SCell activation procedure based on the set of cross-component carrier reference signals. In some embodiments, operation 1108 is similar to operation 1008.

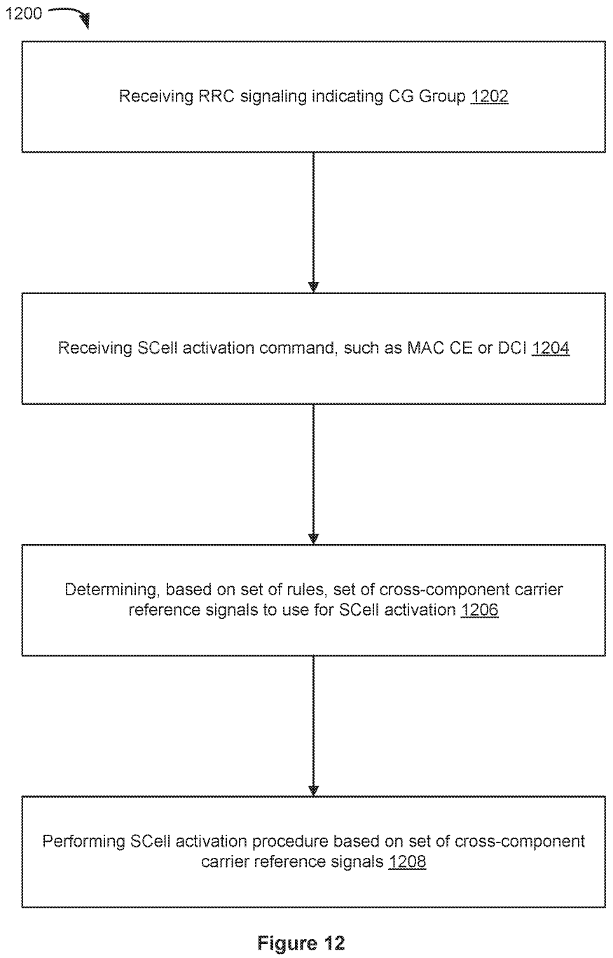

FIG. 12 illustrates an example of an operational flow/algorithmic structure 1200 for a rule-based SCell activation, in accordance with some embodiments. Operations of the operational flow/algorithmic structure 1200 are specific to using a set of rules associated with an SCell activation. As such, these operations can be implemented as sub-operations of the operational flow/algorithmic structure 1000 of FIG. 10. Some of the operations may be similar. The similarities are not repeated herein in the interest of brevity by equivalently apply to the operational flow/algorithmic structure 1200.

The operation flow/algorithmic structure 1200 may include, at 1202, receiving RRC signaling indicating a component carrier group. In some embodiments, the UE receives from the network node an RRC message that indicates the component carrier group and the associated component carriers.

The operation flow/algorithmic structure 1200 may also include, at 1204, receiving an SCell activation command, such as MAC CE or DCI. In some embodiments, the SCell activation command need not indicate a TCI state. Instead, the SCell activation command may indicate the component carrier group (e.g., by having bit values set to the value of the component carrier group's identifier).

The operation flow/algorithmic structure 1200 may also include, at 1206, determining, based on set of rules, a set of cross-component carrier reference signals to use for SCell activation. In some embodiments, the set of rules can include one or more of the rules described in FIG. 8. Generally, the rules indicate to the UE a selection of at least one of a QCL-TypeA reference signal on an activated component carrier of the component carrier group or a QCL-TypeD reference signal on this activated component carrier or another activated component carrier of the component carrier group.

The operation flow/algorithmic structure 1200 may also include, at 1208, performing an SCell activation procedure based on the set of cross-component carrier reference signals. In some embodiments, operation 1208 is similar to operation 1008.

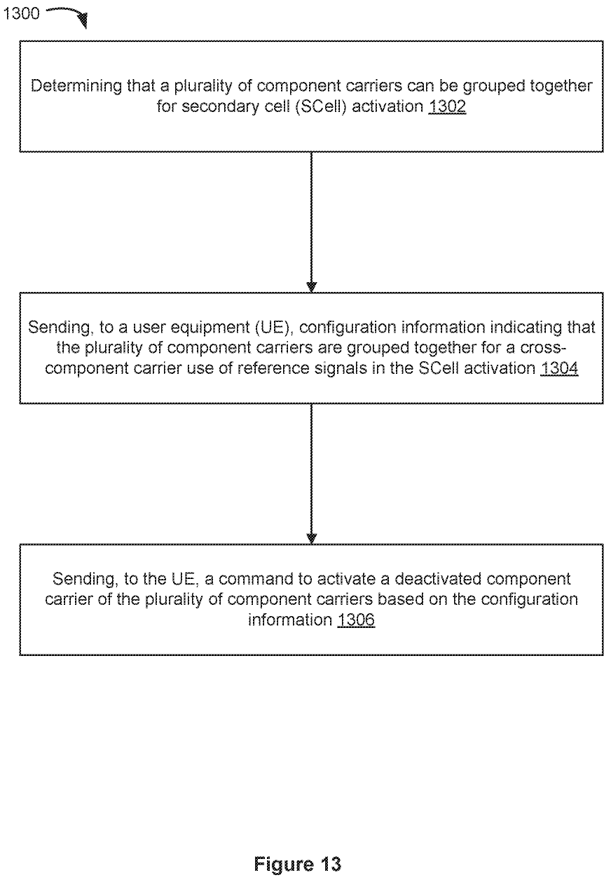

FIG. 13 illustrates another example of an operational flow/algorithmic structure 1300 for an SCell activation, in accordance with some embodiments. A network node, such as the gNB 108, network node 220, or gNB 1600, or components thereof (e.g., processors 1604), can implement the operational flow/algorithmic structure 1300 to improve an SCell activation procedure. The network node can communicate with a UE to activate an SCell for the UE, where the SCell uses a component carrier.

The operation flow/algorithmic structure 1300 may include, at 1302, determining that a plurality of component carriers can be grouped together for an SCell activation. In some embodiments, this determination is based on the component carriers being intra-band component carriers (contiguous or non-contiguous) and/or inter-band component carriers in adjacent bands, such that an RF chain can be shared and can be taken advantage in terms of supporting QCL-Type A and QLC-Type D relationships.

The operation flow/algorithmic structure 1300 may also include, at 1304, sending, to the UE, configuration information indicating that the plurality of component carriers are grouped together for a cross-component carrier use of reference signals in the SCell activation. The configuration information can be sent via RRC signaling. In some embodiments, the configuration information indicates an identifier of a component carrier group and associates this identifier with the plurality of component carriers. In additional or alternative embodiments, the configuration information indicates a TCI state configuration per component carrier, where the TCI state configuration of a component carrier indicates reference signals and their associations with other component carriers of the plurality of component carriers.

The operation flow/algorithmic structure 1300 may also include, at 1306, sending, to the UE, a command to activate a deactivated component carrier of the plurality of component carriers based on the configuration information. In some embodiments, the command is an SCell activation command (e.g., MAC CE or DCI) that at least identifies the deactivated component carrier. Further, the SCell activation command can also identify a TCI state and/or other information by including the fields of the SCell activation command 800 of FIG. 8.

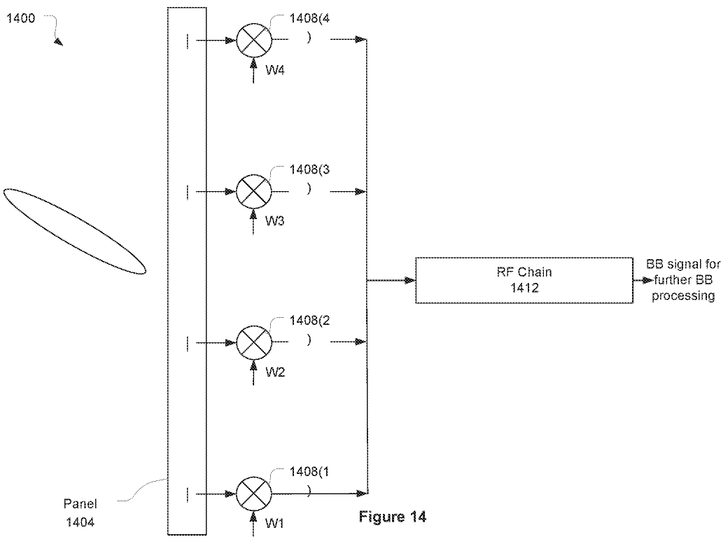

FIG. 14 illustrates receive components 1400 of the UE 104, in accordance with some embodiments. The receive components 1400 may include an antenna panel 1404 that includes a number of antenna elements. The panel 1404 is shown with four antenna elements, but other embodiments may include other numbers.

The antenna panel 1404 may be coupled to analog beamforming (BF) components that include a number of phase shifters 1408(1)-1408(4). The phase shifters 1408(1)-1408(4) may be coupled with a radio-frequency (RF) chain 1412. The RF chain 1412 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values, to the phase shifters 1408(1)-1408(4) to provide a receive beam at the antenna panel 1404. These BF weights may be determined based on the channel-based beamforming.

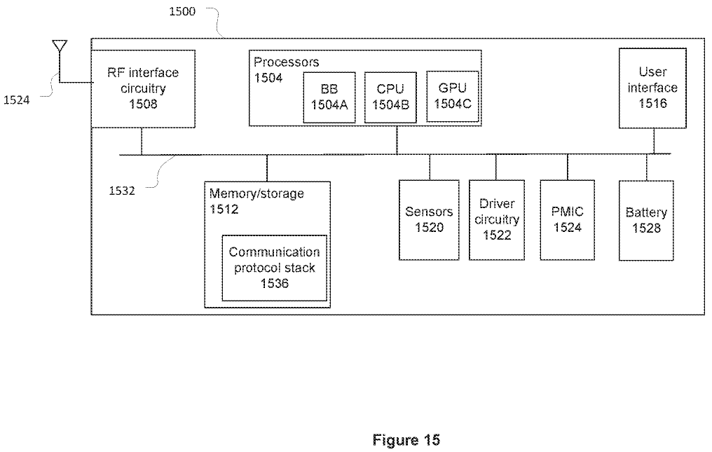

FIG. 15 illustrates a UE 1500, in accordance with some embodiments. The UE 1500 may be similar to and substantially interchangeable with UE 104 of FIG. 1.

Similar to that described above with respect to UE 104, the UE 1500 may be any mobile or non-mobile computing device, such as mobile phones, computers, tablets, industrial wireless sensors (e.g., microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (e.g., cameras, video cameras, etc.), wearable devices, or relaxed-IoT devices. In some embodiments, the UE may be a reduced capacity UE or NR-Light UE.

The UE 1500 may include processors 1504, RF interface circuitry 1508, memory/storage 1512, user interface 1516, sensors 1520, driver circuitry 1522, power management integrated circuit (PMIC) 1524, and battery 1528. The components of the UE 1500 may be implemented as integrated circuits (ICs); portions thereof; discrete electronic devices; or other modules, logic, hardware, software, firmware, or a combination thereof. The block diagram of FIG. 15 is intended to show a high-level view of some of the components of the UE 1500. However, some of the components shown may be omitted, additional components may be present, and different arrangements of the components shown may occur in other implementations.

The components of the UE 1500 may be coupled with various other components over one or more interconnects 1532, which may represent any type of interface, input/output, bus (local, system, or expansion), transmission line, trace, optical connection, etc. that allows various circuit components (on common or different chips or chipsets) to interact with one another.

The processors 1504 may include processor circuitry, such as baseband processor circuitry (BB) 1504A, central processor unit circuitry (CPU) 1504B, and graphics processor unit circuitry (GPU) 1504C. The processors 1504 may include any type of circuitry or processor circuitry that executes or otherwise operates computer-executable instructions, such as program code, software modules, or functional processes from memory/storage 1512 to cause the UE 1500 to perform operations as described herein.

In some embodiments, the baseband processor circuitry 1504A may access a communication protocol stack 1536 in the memory/storage 1512 to communicate over a 3GPP compatible network. In general, the baseband processor circuitry 1504A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1508.

The baseband processor circuitry 1504A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1504A may also access group information 1524 from memory/storage 1512 to determine search space groups in which a number of repetitions of a PDCCH may be transmitted.

The memory/storage 1512 may include any type of volatile or non-volatile memory that may be distributed throughout the UE 1500. In some embodiments, some of the memory/storage 1512 may be located on the processors 1504 themselves (e.g., L1 and L2 cache), while other memory/storage 1512 is external to the processors 1504 but accessible thereto via a memory interface. The memory/storage 1512 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 1508 may include transceiver circuitry and a radio frequency front module (RFEM) that allows the UE 1500 to communicate with other devices over a radio access network. The RF interface circuitry 1508 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1524 and proceed to filter and amplify (with a low-noise amplifier) the signal. The signal may be provided to a receiver of the transceiver that down-converts the RF signal into a baseband signal that is provided to the baseband processor of the processors 1504.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1524.

In various embodiments, the RF interface circuitry 1508 may be configured to transmit/receive signals in a manner compatible with NR access technologies.

The antenna 1524 may include a number of antenna elements that each convert electrical signals into radio waves to travel through the air and to convert received radio waves into electrical signals. The antenna elements may be arranged into one or more antenna panels. The antenna 1524 may have antenna panels that are omnidirectional, directional, or a combination thereof to enable beamforming and multiple input, multiple output communications. The antenna 1524 may include microstrip antennas, printed antennas fabricated on the surface of one or more printed circuit boards, patch antennas, phased array antennas, etc. The antenna 1524 may have one or more panels designed for specific frequency bands including bands in FR1 or FR2.

The user interface circuitry 1516 includes various input/output (I/O) devices designed to enable user interaction with the UE 1500. The user interface 1516 includes input device circuitry and output device circuitry Input device circuitry includes any physical or virtual means for accepting an input including, inter alia, one or more physical or virtual buttons (e.g., a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (e.g., binary status indicators, such as light emitting diodes (LEDs)) and multi-character visual outputs, or more complex outputs, such as display devices or touchscreens (e.g., liquid crystal displays (LCDs), LED displays, quantum dot displays, projectors, etc.), with the output of characters, graphics, multimedia objects, and the like being generated or produced from the operation of the UE 1500.

The sensors 1520 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (e.g., thermistors); pressure sensors; barometric pressure sensors; gravimeters; altimeters; image capture devices (e.g., cameras or lensless apertures); light detection and ranging sensors; proximity sensors (e.g., infrared radiation detector and the like); depth sensors; ambient light sensors; ultrasonic transceivers; microphones or other like audio capture devices; etc.

The driver circuitry 1522 may include software and hardware elements that operate to control particular devices that are embedded in the UE 1500, attached to the UE 1500, or otherwise communicatively coupled with the UE 1500. The driver circuitry 1522 may include individual drivers allowing other components to interact with or control various input/output (I/O) devices that may be present within, or connected to, the UE 1500. For example, driver circuitry 1522 may include a display driver to control and allow access to a display device, a touchscreen driver to control and allow access to a touchscreen interface, sensor drivers to obtain sensor readings of sensor circuitry 1520 and control and allow access to sensor circuitry 1520, drivers to obtain actuator positions of electro-mechanic components or control and allow access to the electro-mechanic components, a camera driver to control and allow access to an embedded image capture device, audio drivers to control and allow access to one or more audio devices.

The PMIC 1524 may manage power provided to various components of the UE 1500. In particular, with respect to the processors 1504, the PMIC 1524 may control power-source selection, voltage scaling, battery charging, or DC-to-DC conversion.

In some embodiments, the PMIC 1524 may control, or otherwise be part of, various power saving mechanisms of the UE 1500. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1500 may power down for brief intervals of time and thus save power. If there is no data traffic activity for an extended period of time, then the UE 1500 may transition off to an RRC_Idle state, where it disconnects from the network and does not perform operations, such as channel quality feedback, handover, etc. The UE 1500 goes into a very low power state and it performs paging where again it periodically wakes up to listen to the network and then powers down again. The UE 1500 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1528 may power the UE 1500, although in some examples the UE 1500 may be mounted deployed in a fixed location, and may have a power supply coupled to an electrical grid. The battery 1528 may be a lithium ion battery, a metal-air battery, such as a zinc-air battery, an aluminum-air battery, a lithium-air battery, and the like. In some implementations, such as in vehicle-based applications, the battery 1528 may be a typical lead-acid automotive battery.

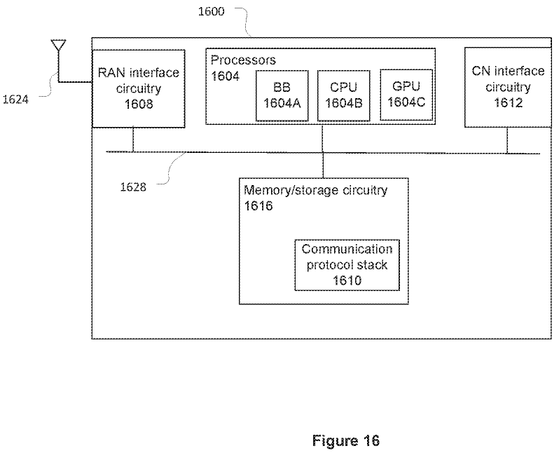

FIG. 16 illustrates a gNB 1600, in accordance with some embodiments. The gNB node 1600 may be similar to and substantially interchangeable with gNB 108. A base station, such as the base station 112, can have the same or similar components as the gNB 1600.

The gNB 1600 may include processors 1604, RF interface circuitry 1608, core network (CN) interface circuitry 1612, and memory/storage circuitry 1616.

The components of the gNB 1600 may be coupled with various other components over one or more interconnects 1628.

The processors 1604, RF interface circuitry 1608, memory/storage circuitry 1616 (including communication protocol stack 1610), antenna 1624, and interconnects 1628 may be similar to like-named elements shown and described with respect to FIG. 10.

The CN interface circuitry 1612 may provide connectivity to a core network, for example, a Fifth Generation Core network (5GC) using a 5GC-compatible network interface protocol, such as carrier Ethernet protocols, or some other suitable protocol. Network connectivity may be provided to/from the gNB 1600 via a fiber optic or wireless backhaul. The CN interface circuitry 1612 may include one or more dedicated processors or FPGAs to communicate using one or more of the aforementioned protocols. In some implementations, the CN interface circuitry 1612 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method implemented by a user equipment (UE), the method comprising: receiving, from a network node, configuration information indicating that a plurality of component carriers are grouped together for cross-component carrier use of reference signals; determining a trigger for a secondary cell (SCell) activation of a deactivated component carrier of the plurality of component carriers; determining, based on the configuration information, that a first reference signal on an activated component carrier of the plurality of component carriers is usable for the SCell activation; and performing, based on the first reference signal, an SCell activation procedure to activate the deactivated component carrier.

Example 2 includes the method of example 1, wherein the configuration information is received via radio resource control (RRC) signaling and includes an identifier of a component carrier group corresponding to the plurality of component carriers.

Example 3 includes the method of any preceding example, wherein the configuration information indicates a power offset value for a component carrier pair formed by the activated component carrier and the deactivated component carrier, and wherein the SCell activation procedure is performed based on the power offset value.

Example 4 includes the method of any preceding example, wherein a power offset value is determined, by the UE based on a frequency separation between the activated component carrier and the deactivated component carrier, for a component carrier pair formed by the activated component carrier and the deactivated component carrier, and wherein the SCell activation procedure is performed based on the power offset value.

Example 5 includes the method of any preceding example, wherein the first reference signal includes a quasi-colocation (QCL)-TypeA reference signal is used for at least one of time and frequency tracking or antenna gain control setting.

Example 6 includes the method of any preceding example, wherein the first reference signal includes a quasi-colocation (QCL)-TypeD reference signal that is used to perform beam sweeping for aperiodic channel state information (CSI) reference signal reception.

Example 7 includes the method of any preceding example, further comprising: determining a second reference signal based on the configuration information, wherein the SCell activation procedure is performed further based on the second reference signal, wherein the first reference signal includes a quasi-colocation (QCL)-TypeA reference signal, and wherein the second reference signal includes a QCL-TypeD reference signal.

Example 8 includes the method of any preceding example, wherein the configuration information includes a transmission configuration indicator (TCI) state configuration associated with the deactivated component carrier, wherein the TCI state configuration indicates the first reference signal and the activated component carrier where the first reference signal is transmitted.

Example 9 includes the method of example 8, wherein the TCI state configuration further indicates a second reference signal on the activated component carrier or another activated component carrier, and wherein the SCell activation procedure is performed further based on the second reference signal.

Example 10 includes the method of example 9, wherein the TCI state configuration further indicates, for each activated component carrier, a bandwidth part (BWP) identifier, wherein the first reference signal includes a quasi-colocation (QCL)-TypeA reference signal, and wherein the second reference signal includes a QCL-TypeD reference signal.

Example 11 includes the method of example 8, wherein the TCI state configuration includes a plurality of TCI states and indicates, per TCI state, a set of cross-component carrier reference signals to use for activating the deactivated component carrier.

Example 12 includes the method of example 11, wherein the TCI state configuration indicates, per TCI state, a first combination of a first cell index, a first bandwidth part (BWP) identifier, and a first type and a first index of the first reference signal and a correspondence of the first combination with a quasi-colocation (QCL)-TypeA reference signal.

Example 13 includes the method of example 12, wherein the TCI state configuration further indicates, per TCI state, a second combination of a second cell index, a second BWP identifier, and a second type and a second index of a second reference signal and a correspondence of the second combination with a QCL-TypeD reference signal.

Example 14 includes the method of example 11, wherein the TCI state configuration is received via resource control (RRC) signaling, wherein the trigger includes an identifier of a TCI state from the TCI state configuration, wherein a target set of cross-component carrier reference signals is determined based on the identifier of the TCI state, and wherein the SCell activation procedure is performed further based on the target set of cross-component carrier reference signals.

Example 15 includes the method of example 11, wherein determining the trigger comprises receiving a media access control (MAC) control element (CE) or downlink control information (DCI) indicating a TCI state of the plurality of TCI states.

Example 16 includes the method of example 15, wherein the TCI state indicated by the MAC CE or the DCI is associated, in the TCI state configuration, with the first reference signal on the activated component carrier and a second reference signal on the activated component carrier or another activated component carrier, wherein the first reference signal includes either one of a quasi-colocation (QCL)-TypeA reference signal or a QCL-TypeD reference signal, and wherein the second reference signal includes a remaining of the QCL-TypeA reference signal or the QCL-TypeD reference signal.

Example 17 includes the method of example 15, wherein the MAC CE or the DCI includes a first field that indicates an activation/deactivation status of an SCell that corresponds to the deactivated component carrier, a second field that indicates the indicates the TCI state, and a third field that indicates whether a temporary reference signal or the set of cross-component carrier reference signals is to be used,

Example 18 includes the method of example 17, wherein first bits in the first field are set to indicate that the SCell is to be activated, second bits in the second field are set to have a value of an identifier of the TCI state, and third bits in the third field are set to indicate the use of the set of cross-component carrier reference signals.

Example 19 includes the method of example 17, wherein the MAC CE or the DCI further includes a fourth field that triggers aperiodic channel state information (CSI) reference signal transmission that is quasi-collocated with a second reference signal of the set of cross-component carrier reference signals.

Example 20 includes the method of any of the preceding examples, further comprising: determining, based on the configuration information, a component carrier group that corresponds to the plurality of component carriers; and determining, based on a set of rules, a set of cross-component carrier reference signals to use for the SCell activation, wherein the set of cross-component carrier reference signals includes the first reference signal.

Example 21 includes the method of example 20, wherein determining the trigger comprises receiving an SCell activation command, wherein the set of cross-component carrier reference signals includes a second reference signal on the activated component carrier or another activated component carrier, wherein the first reference signal includes a quasi-colocation (QCL)-TypeA reference signal, and wherein the second reference signal includes a QCL-TypeD reference signal.

Example 22 includes the method of example 21, wherein the set of rules indicates that a resource set carrying the QCL-TypeA reference signal on any activated component carrier and occurring first after a number of slots from the slot where the SCell activation command is received is to be used as the first reference signal for the SCell activation, and wherein the set of rules further indicates that a resource set carrying the QCL-TypeD reference signal on any activated component carrier and occurring first after the number of slots from the slot where the SCell activation command is received is to be used as the second reference signal for the SCell activation.

Example 23 includes the method of example 22, wherein the set of rules indicates that if an overlap in the time domain occurs between (i) a first QCL-TypeA reference signal on a first activated component carrier within a same frequency band as the deactivated component carrier and (ii) a second QCL-TypeA reference signal on a second activated component carrier in a different frequency band than the deactivated component carrier, the first QCL-TypeA reference signal is to be used for the SCell activation.

Example 24 includes the method of example 22, wherein the set of rules indicates that if an overlap in the time domain occurs between (i) a first QCL-TypeD reference signal on a first activated component carrier within a same frequency band as the deactivated component carrier and (ii) a second QCL-TypeD reference signal on a second activated component carrier in a different frequency band than the deactivated component carrier, the first QCL-TypeD reference signal is to be used for the SCell activation.

Example 25 includes the method of example 22, wherein the set of rules indicates that if an overlap in the time domain occurs between (i) a first QCL-TypeA reference signal on a first activated component carrier within a same frequency band as the deactivated component carrier and (ii) a second QCL-TypeA reference signal on a second activated component carrier in the same frequency band and having a larger component carrier index than the first activated component carrier, the first QCL-TypeA reference signal is to be used for the SCell activation based on the lower component carrier index of the first activated component carrier relative to the second activated component carrier.

Example 26 includes the method of example 22, wherein the set of rules indicates that if an overlap in the time domain occurs between (i) a first QCL-TypeD reference signal on a first activated component carrier within a same frequency band as the deactivated component carrier and (ii) a second QCL-TypeD reference signal on a second activated component carrier in the same frequency band and having a larger component carrier index than the first activated component carrier, the first QCL-TypeD reference signal is to be used for the SCell activation based on the lower component carrier index of the first activated component carrier relative to the second activated component carrier.

Example 27 includes the method of example 22, wherein the set of rules indicates that if a triggered aperiodic channel state information (CSI) reference signal on an SCell being activated and corresponding to the deactivated component carrier overlaps in the time domain with the QCL-TypeD reference signal, subsequent receptions on the SCell have a QCL-TypeD association with the QCL-TypeD reference signal.

Example 28 includes the method of example 22, wherein the set of rules indicates that subsequent receptions on an SCell being activated and corresponding to the deactivated component carrier have a QCL-TypeD association with a demodulation reference signal (DMRS) of a physical download control channel (PDCCH) scheduling the SCell activation command or a physical download shared channel (PDSCH) carrying the SCell activation command.

Example 29 includes a method implemented by a network node, the method comprises: determining that a plurality of component carriers can be grouped together for secondary cell (SCell) activation; sending, to a user equipment (UE), configuration information indicating that the plurality of component carriers are grouped together for a cross-component carrier use of reference signals in the SCell activation; and sending, to the UE, a command to activate a deactivated component carrier of the plurality of component carriers based on the configuration information.

Example 30 includes the method of any of the preceding examples, wherein the determining that the plurality of component carriers can be grouped together is based on the plurality of component carriers being (i) intra-band component carriers or (ii) inter-band component carriers at adjacent bands.

Example 31 includes the method of any of the preceding examples, wherein the configuration information is sent via radio resource control (RRC) signaling and includes an identifier of a component carrier group corresponding to the plurality of component carriers.

Example 32 includes the method of any of the preceding examples, wherein the configuration information is sent via radio resource control (RRC) signaling and includes a transmission configuration indicator (TCI) state configuration associated with the deactivated component carrier, wherein the TCI state configuration indicates an activated component carrier and a first reference signal on an activated component carrier of the plurality of component carriers.

Example 33 includes the method of example 32, wherein the TCI state configuration includes a plurality of TCI states and indicates, per TCI state, a set of cross-component carrier reference signals to use for activating the deactivated component carrier, and wherein sending the command comprises sending a media access control (MAC) control element (CE) or downlink control information (DCI) that indicates a TCI state of the plurality of TCI states.

Example 34 includes a UE comprising means to perform one or more elements of a method described in or related to any of the examples 1-28 and 30-33.

Example 35 includes one or more non-transitory computer-readable media comprising instructions to cause a UE, upon execution of the instructions by one or more processors of the UE, to perform one or more elements of a method described in or related to any of the examples 1-28 and 30-33.

Example 36 includes a UE comprising logic, modules, or circuitry to perform one or more elements of a method described in or related to any of the examples 1-28 and 30-33.

Example 37 includes a UE comprising: one or more processors and one or more computer-readable media comprising instructions that, when executed by the one or more processors, cause the one or more processors to perform one or more elements of a method described in or related to any of the examples 1-28 and 30-33.

Example 38 includes a system comprising means to perform one or more elements of a method described in or related to any of the examples 1-28 and 30-33.

Example 39 includes a network node comprising means to perform one or more elements of a method described in or related to any of the examples 2-6, 8-14, 16-19, and 29-33.

Example 40 includes one or more non-transitory computer-readable media comprising instructions to cause a network, upon execution of the instructions by one or more processors of the network node, to perform one or more elements of a method described in or related to any of the examples 2-6, 8-14, 16-19, and 29-33.

Example 41 includes a network node comprising logic, modules, or circuitry to perform one or more elements of a method described in or related to any of the examples 2-6, 8-14, 16-19, and 29-33.

Example 42 includes a network node comprising: one or more processors and one or more computer-readable media comprising instructions that, when executed by the one or more processors, cause the one or more processors to perform one or more elements of a method described in or related to any of the examples 2-6, 8-14, 16-19, and 29-33.

Example 43 includes a system comprising means to perform one or more elements of a method described in or related to any of the examples 2-6, 8-14, 16-19, and 29-33.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-25. (canceled)

26. A method implemented by a user equipment (UE), the method comprising:
receiving, from a network node, configuration information indicating that a plurality of component carriers are grouped together for cross-component carrier use of reference signals;
determining a trigger for a secondary cell (SCell) activation of a deactivated component carrier of the plurality of component carriers;
determining, based on the configuration information, that a first reference signal on an activated component carrier of the plurality of component carriers is usable for the SCell activation; and
performing, based on the first reference signal, an SCell activation procedure to activate the deactivated component carrier.

27. The method of claim 26, wherein the configuration information is received via radio resource control (RRC) signaling and includes an identifier of a component carrier group corresponding to the plurality of component carriers.

28. The method of claim 26, wherein the configuration information indicates a power offset value for a component carrier pair formed by the activated component carrier and the deactivated component carrier, and wherein the SCell activation procedure is performed based on the power offset value.

29. The method of claim 26, wherein a power offset value is determined, by the UE based on a frequency separation between the activated component carrier and the deactivated component carrier, for a component carrier pair formed by the activated component carrier and the deactivated component carrier, and wherein the SCell activation procedure is performed based on the power offset value.

30. The method of claim 26, wherein the first reference signal include: (i) s a quasi-colocation (QCL)-TypeA reference signal is used for at least one of time and frequency tracking or antenna gain control setting, or (ii) a quasi-colocation (QCL)-TypeD reference signal that is used to perform beam sweeping for aperiodic channel state information (CSI) reference signal reception.

31. The method of claim 26, further comprising:
determining a second reference signal based on the configuration information, wherein the SCell activation procedure is performed further based on the second reference signal, wherein the first reference signal includes a quasi-colocation (QCL)-TypeA reference signal, and wherein the second reference signal includes a QCL-TypeD reference signal.

32. The method of claim 26, wherein the configuration information includes a transmission configuration indicator (TCI) state configuration associated with the deactivated component carrier, wherein the TCI state configuration indicates the first reference signal and the activated component carrier where the first reference signal is transmitted.

33. The method of claim 32, wherein the TCI state configuration further indicates a second reference signal on the activated component carrier or another activated component carrier, and wherein the SCell activation procedure is performed further based on the second reference signal.

34. The method of claim 32, wherein the TCI state configuration includes a plurality of TCI states and indicates, per TCI state, a set of cross-component carrier reference signals to use for activating the deactivated component carrier.

35. The method of claim 34, wherein the TCI state configuration indicates, per TCI state, a first combination of a first cell index, a first bandwidth part (BWP) identifier, and a first type and a first index of the first reference signal and a correspondence of the first combination with a quasi-colocation (QCL)-TypeA reference signal.

36. The method of claim 34, wherein determining the trigger comprises receiving a media access control (MAC) control element (CE) or downlink control information (DCI) indicating a TCI state of the plurality of TCI states.

37. A user equipment (UE) comprising:
one or more processors; and
one or more memories storing computer-readable instructions that, upon execution by the one or more processors, configure the UE to:
receive, from a network node, configuration information indicating that a plurality of component carriers are grouped together for cross-component carrier use of reference signals;
determine a trigger for a secondary cell (SCell) activation of a deactivated component carrier of the plurality of component carriers;
determine, based on the configuration information, that a first reference signal on an activated component carrier of the plurality of component carriers is usable for the SCell activation; and
perform, based on the first reference signal, an SCell activation procedure to activate the deactivated component carrier.

38. The UE of claim 37, wherein the execution of the computer-readable instructions further configures the UE to:
determine, based on the configuration information, a component carrier group that corresponds to the plurality of component carriers; and
determine, based on a set of rules, a set of cross-component carrier reference signals to use for the SCell activation, wherein the set of cross-component carrier reference signals includes the first reference signal.

39. The UE of claim 38, wherein determining the trigger comprises receiving an SCell activation command, wherein the set of cross-component carrier reference signals includes a second reference signal on the activated component carrier or another activated component carrier, wherein the first reference signal includes a quasi-colocation (QCL)-TypeA reference signal, and wherein the second reference signal includes a QCL-TypeD reference signal.

40. The UE of claim 38, wherein the set of rules indicates that if an overlap in the time domain occurs between (i) a first QCL-TypeA reference signal on a first activated component carrier within a same frequency band as the deactivated component carrier and (ii) a second QCL-TypeA reference signal on a second activated component carrier in a different frequency band than the deactivated component carrier, the first QCL-TypeA reference signal is to be used for the SCell activation.

41. The UE of claim 38, wherein the set of rules indicates that if an overlap in the time domain occurs between (i) a first QCL-TypeD reference signal on a first activated component carrier within a same frequency band as the deactivated component carrier and (ii) a second QCL-TypeD reference signal on a second activated component carrier in the same frequency band and having a larger component carrier index than the first activated component carrier, the first QCL-TypeD reference signal is to be used for the SCell activation based on a lower component carrier index of the first activated component carrier relative to the second activated component carrier.

42. A network node comprising:
one or more processors; and
one or more memories storing computer-readable instructions that, upon execution by the one or more processors, configure the network node to:
determine that a plurality of component carriers can be grouped together for secondary cell (SCell) activation;
send, to a user equipment (UE), configuration information indicating that the plurality of component carriers are grouped together for a cross-component carrier use of reference signals in the SCell activation; and
send, to the UE, a command to activate a deactivated component carrier of the plurality of component carriers based on the configuration information.

43. The network node of claim 42, wherein the determining that the plurality of component carriers can be grouped together is based on the plurality of component carriers being (i) intra-band component carriers or (ii) inter-band component carriers at adjacent bands.

44. The network node of claim 42, wherein the configuration information is sent via radio resource control (RRC) signaling and includes an identifier of a component carrier group corresponding to the plurality of component carriers.

45. The network node of claim 42, wherein the configuration information is sent via radio resource control (RRC) signaling and includes a transmission configuration indicator (TCI) state configuration associated with the deactivated component carrier, wherein the TCI state configuration indicates an activated component carrier and a first reference signal on an activated component carrier of the plurality of component carriers.
